(19) United States
(12) Patent Application Publication
(10) Pub. No.: US 2005/0074529 A1
(43) Pub. Date: Apr. 7, 2005

(54) Method and apparatus for transporting visualization information on a switched underlay network

(75) Inventors: Howard Cohen, Palo Alto, CA (US); Tal Lavian, Sunnyvale, CA (US); Richard Brand, Palo Alto, CA (US)

Correspondence Address: JOHN C. GORECKI, ESQ., 180 HEMLOCK HILL ROAD, CARLISLE, MA, 01741, US

(73) Assignee: Nortel Networks Limited, St. Laurent (CA)

(21) Appl. No.: 10/870,468

(22) Filed: Jun. 17, 2004

Related U.S. Application Data
(60) Provisional application No. 60/508,524, filed on Oct. 3, 2003.

(51) Int. Cl. H04J 3/22

(52) U.S. Cl. 426/106; 718/100

(57) ABSTRACT

A visualization display network is created such that images to be displayed at the visualization presentation center(s) are formatted for direct display on the viewing terminals without requiring significant additional processing at the visualization presentation center. For example, the display terminals at the visualization presentation center may be configured to display signals received in a standard color format such as RGB, and the signals output from the visualization processing center and transported on a switched underlay optical network may be formed in the same color format. A visualization transfer service is provided to reserve resources on the switched underlay optical network and to coordinate visualization events between the visualization processing center, network, and visualization presentation center. Network resources may be scheduled in real time on demand or may be scheduled to be provided at a predetermined optionally under-constrained time.

### CROSS REFERENCE TO RELATED APPLICATIONS

This application claims priority to U.S. Provisional Patent Application No. 60/508,524, filed Oct. 3, 2003, and to U.S. patent application Ser. No. 10/719,225, filed Nov. 21, 2003, the content of each of which is hereby incorporated herein by reference.

### BACKGROUND

1. Field

This application relates to communication networks and, more particularly, to a method and apparatus for transporting visualization information on a switched underlay optical network.

2. Description of the Related Art

Data communication networks may include various computers, servers, nodes, routers, switches, hubs, proxies, and other devices coupled to and configured to pass data to one another. These devices will be referred to herein as “network elements,” and may provide a variety of network resources such as communication links and bandwidths. Conventionally, data has been communicated through the data communication networks by passing protocol data units (or cells, frames, or segments) between the network elements by utilizing one or more types of network resources. A particular protocol data unit may be handled by multiple network elements and cross multiple communication links as it travels between its source and its destination over the network.

Conventional data networks are packet switched networks, in which data is transmitted in packet form which allows the packets to be commingled with other packets from other network subscribers. As the size of a data transfer increases in size or the sustained bandwidth required for the transmission increases, the ability to handle the data transfer on a packet network decreases. For example, a traditional packet switched network, such as a TCP/IP based communication network, will tend to become overloaded and incapable or inefficient at handling large data transfers or high bandwidth data transfers. Thus, it is desirable, at least in some instances, to obtain a dedicated path through the network to handle the transfer.

One application that requires a very high sustained transmission rate is high resolution visualization. For example, visualization processing may be performed by a group of processors and then presented on one or more high resolution display monitors at a visualization presentation center. The computers performing the visualization processing in the visualization processing centers may process multiple terabytes of data to generate a series of high resolution images, which must then be transported to the visualization presentation center to be displayed. Where the resolution is required to be high, the amount of data required to generate the visualization presentation can become very large. For example, assume a 9 megapixel display monitor is driven at 30 frames per second, and each pixel requires 24 bits of information per frame. The bandwidth required to drive this display is 9,000,000 pixels times 24 bits/pixel, times 30 frames per second, or 6.48 gigabits per second. Where there are 8 monitors in the display, 15 monitors in the display, or more, as is becoming common in high resolution visualization presentation centers, the required data throughput from the visualization processing center to the visualization presentation center quickly increases to a sustained data transmission rate approaching or exceeding 100 Gbps.

Because of these extremely high data rates, conventional packet networks are ineffective or incapable of transporting high resolution visualization information. Accordingly, processing facilities for very high resolution visualization have conventionally been provided in the vicinity of the display facility to avoid transporting the data long distances on a network. This limits the ability to have the display viewed by persons not present in the visualization presentation center and dramatically increases the cost associated with creating new visualization presentation centers.

### SUMMARY OF THE DISCLOSURE

As described in greater detail herein, a method and apparatus for transporting visualization information on a switched underlay optical network enables network resources to be obtained for the transmission of visualization information such that high data rate visualization information may be generated at a visualization processing center and transported in real time or at a scheduled time to a remote visualization presentation center. According to an embodiment of the invention, network resources may be scheduled in real time on demand or may be scheduled to be provided at a predetermined optionally under constrained time. This allows optically switched scheduled resources to be provided on a switched underlay network, so that the network can transport visualization information for a visualization event from a visualization processing center to one or more visualization presentation centers.

According to one embodiment of the invention, a visualization display network is created, such that images to be displayed at the visualization presentation center(s) are formatted for direct display on the viewing terminals without requiring significant additional processing at the visualization presentation center. For example, the display terminals at the visualization presentation center may be configured to display signals received in RGB format, and the signals output from the visualization processing center and transported on the switched underlay network may be formed in RGB, YUV or another color format, and may also be encoded according to a conventional television encoding standard such as one of the HDTV standards. In this manner, the processing requirements at the visualization presentation center, and hence the cost of the visualization presentation center, may be minimized. Optionally, according to one embodiment of the invention, the video monitors forming the visualization presentation center may be connected directly to the network to allow direct visualization from the transported images.

### BRIEF DESCRIPTION OF THE DRAWINGS

Aspects of the present invention are pointed out with particularity in the claims. The following drawings disclose one or more embodiments for purposes of illustration only and are not intended to limit the scope of the invention. In the following drawings, like references indicate similar elements. For purposes of clarity, not every element may be labeled in every figure. In the figures:

FIG. 1 is a functional block diagram of an example of a communication network including a visualization transfer service according to an embodiment of the invention;

FIG. 2 is a functional block diagram of a visualization processing center according to an embodiment of the invention;

FIG. 3 is a functional block diagram of a visualization presentation center according to an embodiment of the invention;

FIG. 4 is a functional block diagram of the network architecture of FIG. 1 in greater detail according to an embodiment of the invention;

FIG. 5 is a functional block diagram of the network architecture of FIG. 4 in greater detail according to an embodiment of the invention;

FIG. 6 is a flow diagram illustrating a process of coordinating transportation of a visualization event on a switched underlay network according to an embodiment of the invention;

FIG. 7 is functional block diagram of a visualization management service component of the visualization transfer service according to an embodiment of the invention; and

FIG. 8 is a functional block diagram of a network resources manager component of the visualization transfer service according to an embodiment of the invention.

### DETAILED DESCRIPTION

The following detailed description sets forth numerous specific details to provide a thorough understanding of the invention. However, those skilled in the art will appreciate that the invention may be practiced without these specific details. In other instances, well-known methods, procedures, components, protocols, algorithms, and circuits have not been described in detail so as not to obscure the invention.

Optical networking technology is capable of handling large data transfers at high data throughput rates. In this type of network, an optical fiber may be provisioned to carry hundreds of optical transmission channels, each of which is formed from light at a particular wavelength. Conventionally, each wavelength may be modulated individually to carry data at up to 10 gigabits/second, although the invention is not limited to any particular optical transmission rate. To achieve higher throughput, multiple lambdas can be aggregated to provide bandwidth sufficient to transfer data at very high bandwidths.

According to an embodiment of the invention, a visualization display network is created such that transmissions between one or more visualization processing centers and a visualization presentation center, or a visualization processing center and one or more visualization presentation centers may be carried over an optical network in a format suitable to be displayed on viewing terminals at the visualization presentation center(s) without requiring the visualization data to be generated or otherwise excessively processed at the visualization presentation center(s). For example, the display terminals at the visualization presentation center may be configured to display signals received in RGB format, and the signals output from the visualization processing center and transported on the visualization display network may be formed in RGB format (other color formats may be used as well). In this manner the processing requirements at the visualization presentation center, and hence the cost of the visualization presentation center, may be minimized as the video monitors forming the visualization presentation center may be connected directly to the network. Conventional optical network resources may be reserved for the visualization display network by allocating optical network resources on a switched underlay optical network.

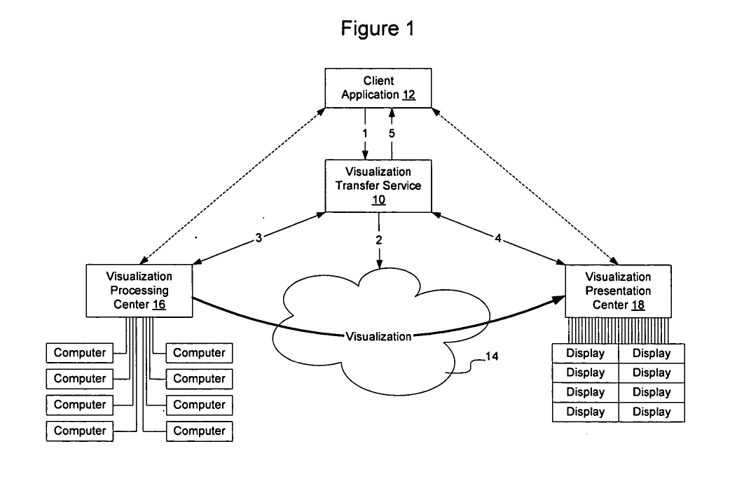

FIG. 1 illustrates an example communication network architecture according to an embodiment of the invention in which a visualization transfer service 10 is configured to coordinate visualization events on behalf of client applications 12 over resources on a switched underlay network 14 to enable visualization events to be created at one or more visualization processing centers 16 and viewed at one or more geographically remote visualization presentation center(s) 18.

The visualization transfer service enables the creation of a visualization display network on a switched underlay network by allowing resources for the transmission of visualization events to be reserved, and by enabling the transmissions to occur in a visualization format that enables the visualizations to be displayed readily by the visualization display centers. The visualization transfer service may also coordinate the visualization, for example, by contacting the visualization processing center 16 and visualization presentation center 18, coordinating delivery of data to the visualization processing center 16, and in many other ways.

In the embodiment illustrated in FIG. 1, the client application 12 may be associated with the visualization processing center 16, the visualization presentation center 18, or may be independent of these entities and not associated with either entity. In the embodiment of FIG. 1, the client application 12 is also illustrated as separate from the visualization transfer service 10. This separation is intended to enable the different functions performed by these entities to be illustrated more readily. When implemented, the client application may be formed as part of the visualization transfer service, e.g. as an interface to the visualization transfer service 10. The visualization transfer service may be maintained in many locations on the network and the invention is not limited to implementation of the visualization transfer service in any particular location.

The visualization transfer service can be implemented with a standard web browser interface to enable interactions with network users, as a web service configured to support computer-to-computer transactions, or as another type of service. Where the visualization transfer service is implemented as a web service, it may be implemented as a stand-alone web service or as a web service configured to interact with other web services. A web service, in this context, is a standard way of making an application available to another computer on a network. Web service implementations are based on web server technology, but use standard protocols to communicate what are essentially remote procedure call requests and responses, rather than browser input and screens for browser display. In one embodiment, the visualization transfer service contains an instance created using the Globus Toolkit, such that its components are configured with Open Grid Services Interface (OGSI) compliant application interfaces within the Open Grid Services Architecture (OGSA). The invention is not limited to this example, however, as other instances may be utilized as well to enable the components to be addressed on the network.

Upon receipt of a request for transportation of a visualization event (arrow 1), the visualization transfer service 10 interrogates the network 14 to obtain the current state of the network, and/or the anticipated state of the network to handle the request during the time period specified in the request (arrow 2). Optionally, where the visualization transfer service is also responsible for coordinating generation of the visualization information by the visualization processing center 16 and/or display of the visualization information at the visualization presentation center 18, the visualization transfer service may also contact these entities (arrows 3 and 4). The visualization transfer service may coordinate with the network resources, visualization processing center, and visualization presentation center in any desired order and the invention is not limited to interfacing with these components in any particular order. The visualization transfer service 10 may also inform the client application 12 of the status of the visualization request (arrow 5) once the visualization event is scheduled, upon commencement of the visualization event, or at any other stage during the process.

Although a single visualization processing center and single visualization presentation center are illustrated in the Figs. and are described in detail herein to not obscure the invention, the invention is not limited to the use of a single visualization processing center and single visualization presentation center. Rather, the visualization presentations may involve any number of visualization processing centers and visualization presentation centers. For example, a given visualization presentation may involve multiple visualization processing centers at geographically dispersed locations or at a given location simultaneously transmitting and/or processing data to be transmitted to a given visualization presentation center. Similarly, the visualization processing centers may cause the data to be multicast to multiple visualization presentation centers to allow the visualization presentation to be viewed at multiple centers. The invention is thus not limited to the example illustrated in the figures as numerous permutations may be possible. Additionally, each visualization presentation center may have multiple visualization displays, such as high resolution monitors, and the invention is not limited to any particular type of monitor or number of monitors at the visualization presentation centers.

Each visualization transmission may require the reservation of multiple lambdas as well, which may be aggregated into a logical channel from the visualization processing center(s) to the visualization presentation center(s). Aggregation may occur in a number of different ways and the invention is not limited to a particular way of using the multiple aggregated lambdas to transport the data. For example, the visualization presentation may be created by numerous computers at the visualization processing center and subsets of those computers may be configured to fill a given optical channel on the logical channel through the network. Alternatively, all the data may be multiplexed onto the several optical channels together and demultiplexed at the visualization presentation center(s). The invention is thus not limited to the particular manner in which the data is passed onto the logical channel.

As discussed in greater detail below, the visualization transfer service 10 maintains a schedule of switched underlay network resource allocations scheduled to occur on the network, historical network usage information, and other network usage information. This information will be referred to herein as “network state information.” Using the network state information, the visualization transfer service 10 schedules the visualization event and allocates bandwidth to the visualization event on the switched underlay network 14. The bandwidth may be used to transport visualization signals in native format, such as in an RGB format, to enable the signals to be used directly to generate images in monitors at the visualization presentation centers. Numerous other formats may be used as well, and the invention is not limited to using the RGB format. Although the signals will be described as being transmitted in native format, the invention is not limited in this manner as other types of processing may be performed on the signals prior to transmission. For example, the signals may be compressed to reduce the amount of bandwidth required to transport the signals or may be encrypted to prevent the signals from being intercepted or altered during transmission. Reverse processes may similarly be performed at the visualization presentation center(s) to restore the native signals without departing from the scope of the invention.

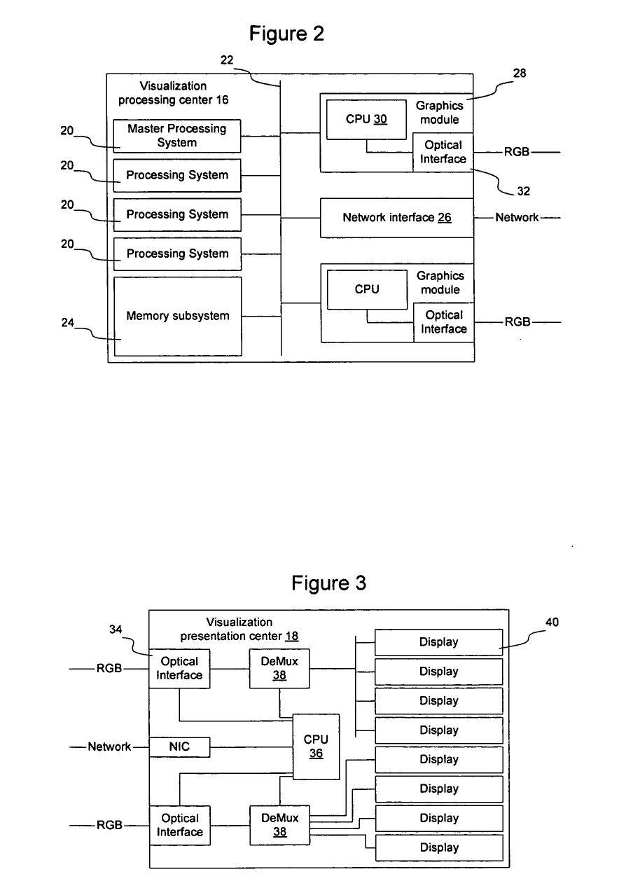

FIG. 2 illustrates a visualization processing center 16 according to an embodiment of the invention. As shown in FIG. 2, a visualization processing center 16 typically includes one or more processing systems 20 connected together to enable the processors of the processing systems to collectively generate visualization information. For example, the processors may be personal computers, servers, or other computer systems, configured to collectively operate on a dataset to generate a visualization. Optionally, one of the processing systems may be a master processing system configured to coordinate operations of the other processing systems. The processing systems may be interconnected via a bus 22, or in another conventional manner.

Data to be processed by the processing systems 20 may be stored on a memory subsystem 24 and interfaced to the processing systems over the bus 22. The data to be used in preparing the visualization may be provided to the visualization processing center 16 from a remote source over a network, via FTP or another transfer mechanism, through a network interface 26. Many other architectures may be used to create a visualization processing system as well, and the invention is not limited to the architecture illustrated in FIG. 2.

In the example embodiment illustrated in FIG. 2, one or more network graphics interface modules 28 are illustrated as being attached to the bus 22 and configured to interface the visualization processing center to an optical transport resource such as an optical fiber in a switched underlay optical network. The switched underlay network may unicast the visualization presentation to a given visualization presentation center or may multicast the visualization presentation to multiple visualization presentation centers depending on the nature of the optical reservation. The network graphic interface modules may be formed as part of one of the processing systems 20, part of the master processing system, memory subsystem 24, network interface 26, or may be formed as a separate optical interface system.

In the embodiment illustrated, the network graphics interface modules are illustrated as having their own CPU 30 and optics components 32 to enable visualization information generated by the processing systems 20 to be formatted according to a format commonly used by computers to drive monitors. For example, in a conventional computer system, a processor in the computer generates information to be displayed. This information is received by a graphics card where it is converted into a format such as the RGB (Red Green Blue) format which is then output to the computer monitor. Other display formats may be used as well. For example, YUV provides an alternative color coding model that may be used to encode analog and digital signals. In the YUV format Y is the luminosity of the black and white signal, and U and V are color difference signals, in which U is red minus Y, and V is blue minus Y. YUV is a common color coding model and, as such, will not be described in greater detail herein. Another color coding model that may be used is the YIQ color model, which is commonly used to encode NTSC (standard color television) video. Other standards such as ITU-R 601, D1, HDTV, NTSC, and other similar standards may be used as well. The invention is not limited to the use of any particular format for coding the signals for transmission from the video processing systems to the video presentation systems. Since the RGB format is a commonly used format, examples of the invention will be described in connection with the RGB format. The invention is not limited in this manner, however, as any number of formats may be used to encode the display signals for transmission.

According to an embodiment of the invention, the network graphics interface modules are graphics cards configured to take the visualization display information from the processing systems and convert it into RGB format. However, rather than outputting the RGB signals over a cable to an attached monitor, the network graphics interface devices are configured to pass the signals to an optical interface module 32 where the signals are output over an optical interface. The optical signals may be formed as analog RGB signals, encoded onto a conventional optical signal transport protocol such as SONET, digitized and framed using a framing procedure such as Generic Framing Procedure (GFP), or otherwise encoded prior to transmission.

FIG. 3 illustrates a visualization presentation center 18 according to an embodiment of the invention. Although a specific architecture of an example visualization presentation center will be explained, the invention is not limited to this particular example. In the example of FIG. 3, the visualization presentation center includes several optical interfaces 34 configured to receive optical signals from optical transport services. The signals may be received from a single visualization processing center or may be received from multiple visualization processing centers. The signals also may relate to a single visualization presentation, or may relate to multiple simultaneous visualization presentations that may be completely unrelated.

The optical interfaces may be controlled by a centralized controller, such as a CPU 36 or other network processor. The optical signals are converted back into RGB signals at the optical interface and sent to a demultiplexer or other conventional processing circuitry 38 to be passed to one or more optical displays. Use of a demultiplexer allows more than one display to be driven by a single optical input, although multiple inputs may be used as well. The demultiplexer passes the signals to displays directly or via a bus. The invention is not limited as to how the signals are passed from the optical interface to the displays.

In the embodiment illustrated in FIG. 3, the optical signals are converted to electrical signals and input directly to the monitors (displays). Since the signals were output in RGB format by the visualization processing center 16, the signals are in a form that may be directly used by the monitors at the visualization presentation center 18. Accordingly, minimal processing must be performed at the visualization presentation center 18 to thereby reduce the cost of that aspect of the display network. Indeed, any computer monitor or group of computer monitors configured with an optical interface may be used as a visualization presentation center as long as the monitor or monitors are configured to display RGB signals.

Although RGB signals have been used to describe an embodiment of the invention, since that is the dominant format used to communicate signals from a computer to a monitor in the current implementation of computer systems, as described above, the invention is not limited in this manner but rather extends to other display protocols usable by visual display devices to display information.

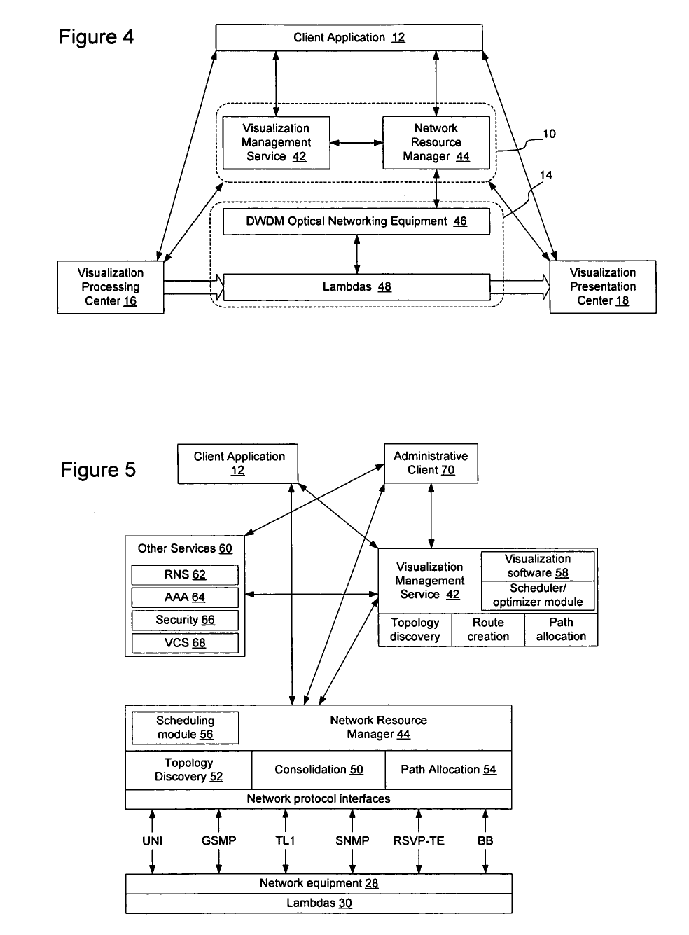

An embodiment of the visualization transfer service will be described in connection with FIGS. 4 and 5. The visualization transfer service may take many different forms and may include multiple logical sub-components. The invention is thus not limited to this particular embodiment, as the visualization transfer service may be configured in many other ways as well.

In the embodiment shown in FIGS. 4 and 5, the visualization transfer service is a system for scheduling and controlling high bandwidth wavelength-switched optical network connectivity to enable visualization events to be transported on a switched underlay optical network. The visualization transfer service enables wavelength switched optical resources to be obtained on demand or to be scheduled at a specified point in time. As described in greater detail below, the visualization transfer service is a scheduled management system for application-level allocations of resources to visualization events over a switched network, which is an underlay for a packet network. In this embodiment, the system is configured to receive requests for visualization events with requested scheduling constraints, and responds with resource availability and scheduled reservations for the switched network resources. Optionally, the visualization transfer service may also manage the visualization event, for example by coordinating delivery of the data to the visualization processing center 16, generation of the visualization images by the visualization processing center 16, and ultimately delivery of the images over the scheduled network resources.

According to one embodiment of the invention, the visualization transfer service may allow data transfers to occur:
on demand (right now);
rigidly in the future (e.g., “tomorrow precisely at 3:30 am”);
loosely in the future (e.g., “Tuesday, after 4 pm but before 6 pm”); and
constrained by events (e.g., “after event A starts or event B terminates”);
   although many other types of reservations may be made as well, and the invention is not limited to a system that is able to implement all of these or only these particular types of network resource reservations. A visualization event request that is not rigidly fixed with precise required parameters will be referred to herein as under-constrained. In this context, an under-constrained resource reservation request enables the request to be fulfilled in two or more ways rather than only in one precise manner.

The visualization transfer service also includes hardware and software configured to enable it to query the network for its topology and the relevant characteristics of segments on the network. It may also include one or more routing modules to plan available and appropriate paths between requested endpoints in (or near) requested time windows, and the ability to allocate specific segment-by-segment paths between endpoints and to relinquish them when the visualization event is done or when the user decides to cancel a visualization event.

In the following discussion, it will be assumed that the data to be processed and form the basis of the visualization event resides at the visualization processing center 16 or is otherwise available to the visualization processing center 16. If the data is not resident at or available to the visualization processing center, it may be moved to the visualization processing center using one or more of the methods and apparatuses discussed in U.S. patent application Ser. No. 10/719,225 filed Nov. 21, 2003, entitled Method and Apparatus for Scheduling Resources on Switched Underlay Networks, the content of each of which is hereby incorporated herein by reference.

Optionally, the VTS may be configured to interact with a resource negotiation service configured to negotiate resources based on client and network policy. Negotiation of resources enables client preferences and network pricing to be used in the scheduling process to obtain more optimal scheduling of events on the network as described in greater detail in U.S. patent application Ser. No. 10/812,581, filed Mar. 30, 2004, and entitled Method and Apparatus for Automated Negotiation for Resources on a Switched Underlay Network, the content of which is hereby incorporated herein by reference.

In addition to scheduling visualization events on the network, the visualization transfer service may also perform one or more additional services. For example, the visualization transfer service may also be configured to provide a rescheduling facility. That is, it may be configured to receive requests to reschedule previously scheduled reservations, and respond with new scheduled reservations, which may or may not implement the requested rescheduling (the “new reservation” may be identical to the old one).

The visualization transfer service may also be configured to provide a notification facility. That is, a reservation request may include a client-listener provided for notification callbacks. The visualization transfer service, in this embodiment, may be configured to issue notifications of changes in the status of the scheduled visualization event to be received by the client-listener.

The visualization transfer service may also be configured to provide facilities for client-side cooperative optimization. That is, a facility may be provided to send requests to the client-listeners for client-initiated rescheduling. In this embodiment, new visualization event requests may be satisfied with the cooperation of another client, so that existing scheduled visualization events may be rescheduled to accommodate new requests. Accordingly, cooperative rescheduling of previously scheduled visualization events may be performed in order to accommodate visualization event requests that cannot be otherwise satisfied, or to accommodate new higher priority requests.

FIG. 4 illustrates an architecture that may be used to implement an embodiment of the invention. As shown in FIG. 4, in this embodiment, client applications 12 interact with a visualization transfer service 10 having a visualization management service 42 and a network resource manager 44 to enable visualization events to be transported by a switched underlay network 14. Interactions between the client 12 and the visualization transfer service 10 may take place using a communication protocol such as Simple Object Access Protocol (SOAP), Extensible Markup Language (XML) messaging, Hyper Text Transfer Protocol (HTTP), Data Web Transfer Protocol (DWTP) or another conventional protocol.

The underlay networks 14 are generally provided by Wavelength Division Multiplexing (WDM) Course WDM (CWDM), Dense WDM, (DWDM), SONET/SDH or other types of optical networking equipment 46 that provides optical transmission capabilities over wavelengths (lambdas) 48 on optical fibers running through the network. The wavelengths on the optical fiber network may also be used to carry packetized traffic when not reserved for visualization events by the visualization transfer service 10. The underlay networks according to one embodiment are considered switched underlay networks because the reservations to be effected on these underlay networks for visualization events involve reservation of one or more lambdas on the network for a particular period of time. The underlay network hence appears as a switched network resource, rather than a shared network resource, since the network resource has been reserved for a particular visualization event rather than being configured to handle all general packet traffic, as is common in a conventional shared network architecture.

As discussed in greater detail below, the network resource manager 44 provides scheduled management of raw network resources (i.e. lambda allocations on demand in real time and scheduled for the future). This service is concerned only with network resources—not data management. The visualization management service 42 provides scheduled management of visualization events. It makes direct use of the network resource manager, and optionally may coordinate the visualization events with the visualization processing center 16 and visualization presentation center 18 involved in the visualization event, as well as optionally other services (described in greater detail below). To achieve optimal performance, the visualization management service 42 is tightly coupled to the network resource manager 44, although the network resource manager can be used by applications independently of the visualization transfer service, for example to reserve resources to transfer data to the visualization processing center 16 prior to the visualization event.

In the architecture of FIG. 4, the network resource manager 44 is configured to interface multiple physical/logical network types interacting via multiple network interface and management protocols. The network resource manager performs topology discovery on the network to discover how the underlay network elements are configured and what resources are deployed throughout the network.

Network information received by the network resource manager is consolidated via a consolidation module 50 for presentation to the visualization management service 42. By consolidation, in this instance, is meant that the network resource manager consolidates information from the underlay networks and presents a single uniform view of them to the upper layers, (either the visualization management service or a directly accessing client application 12). That is, the network resource manager abstracts the actual networks it is managing so that the upper layers do not need to be concerned with details not relevant to their models. For example, a topology discover module 52 may perform topology discovery, in which a network of abstract nodes and links may be returned by the network resource manager to its caller in response to a request for topology discovery. In this regard, each node and link has a set of properties that may be relevant to doing routing for path allocation, etc. But those details not needed for these tasks may be hidden. Accordingly, the consolidation function serves to eliminate information that will not be pertinent to other modules when performing their assigned tasks, and allows disparately organized or formatted information to be presented using a common representation.

The network resource manager 44 also performs path allocation, for example via a path allocation module 54. Specifically, the network resource manager, in connection with topology discovery, may allocate paths through the network that will be used to effect transfers of data or carry visualization information associated with a visualization event. The path allocation module 54, in addition to allocating paths, also effects reservations on the allocated paths so that the allocated paths may be used for a visualization event between a visualization processing center 16 and a visualization presentation center 18.

The network resource manager also includes a scheduling module 56 configured to perform scheduling and optimization of network resources. Unlike the visualization management service, the network resource manager performs scheduling on the network resources without consideration of the availability of the visualization processing center 16 and visualization presentation center 18. Network resources scheduled by the network resource manager are communicated to the visualization management service. Additionally, conflicts in reservations or the inability to fulfill a reservation is transferred to the visualization management service for schedule optimization as discussed in greater detail below. By enabling the network resource manager to perform path allocation and scheduling, as well as network discovery, it is possible to enable the network resource manager to reserve resources directly on behalf of the client applications 12 in addition to through the cooperative interaction between the network resource manager 44 and the visualization management service 42.

The visualization management service 42 supports topology discovery, route creation, path allocation, and interactions with the visualization processing center 16 and visualization presentation center 18. The visualization management service 42 is also the primary module to interface with the resource negotiation service, if implemented, although the invention is not limited in this regard. The topology discovery function of the visualization management service receives abstracted network configuration information from the consolidation module in the network resource manager to have a high level view of the network that will be used to effectuate the visualization transfer. The visualization management service may use information obtained from the visualization processing center and visualization presentation center to perform path allocation and make routing decisions as to how and when the visualization transfer is to take place on the network. These path allocations and routing decisions will be passed to the network resource manager in connection with a scheduled visualization event and used by the network resource manager to reserve resources on the underlay networks.

The visualization software may be configured to interface with the visualization processing center to coordinate delivery of data to the visualization processing center, ascertain processing time constraints associated with preparation of the presentation, and otherwise assist in coordination of the availability of the visualization event with the allocation of network resources. The visualization software may also be configured to interface with the visualization presentation center, if necessary, to ensure the visualization presentation center will not be in use at the proposed scheduled time so that the visualization event may be displayed as anticipated. The visualization software may perform many roles on the network and the invention is not limited to an implementation that performs all of these, or only these, particular described functions.

The visualization management service 42 may interact with one or more other service modules 60 on the network to enable it to have access to advanced functions not directly configured in the visualization management service 42 or the network resources manager 44. Examples of other services that may be available include a resource negotiation service, Authentication, Authorization, and Accounting (AAA) service 64, security service 66, an external visualization coordination service 68, and numerous other services. For example, an AAA service may be provided to enable the applications to be authenticated on the network, enable the network components such as the visualization management service and the network resource manager to ascertain whether the application is authorized to perform transactions on the network, and to allow accounting entries to be established and associated with the proposed transaction.

Additionally, a security service may be interfaced to provide security in connection with the request or visualization information transfer to enable the visualization event to occur in a secure fashion and to enable the visualization information to be protected during the transfer on the network. For example, the security module may support the creation of Virtual Private Network (VPN) tunnels between the various components involved in securing the transfer of the visualization event on the network. Numerous other services may be performed as well and the invention is not limited to an architecture having all of these or only these several described services.

According to one embodiment of the invention, to make the components compatible with GRID computing technology, all application layer interfaces are configured to be OGSI compatible. This enables the network resource manager, visualization management service, and other services, to be treated as resources in a GRID computing environment so that they may be accessed by the applications either through GRID resource manager or directly in much the same way as an application would access other GRID resources. The invention is not limited to this embodiment, however.

As shown in FIG. 5, the network resource manager may be required to interface with many different types of network resources and may need to communicate with the networks and network devices using a number of protocols. In FIG. 5, the network resource manager is illustrated as being configured to communicate with network devices using the following protocols:
User to Network Interface (UNI), a protocol developed to interface Customer Premises Equipment (CPE) such as ATM switches and optical cross connects with public network equipment;
General Switch Management Protocol (GSMP), a general Internet Engineering Task Force (IETF) protocol configured to control network switches;
Transaction Language 1 (TL1), a telecommunications management protocol used extensively to manage SONET and optical network devices;
Simple Network Management Protocol (SNMP), an IETF network monitoring and control protocol used extensively to monitor and adjust Management Information Base (MIB) values on network devices such as routers and switches;
Resource Reservation Protocol—Traffic Engineering (RSVP-TE), a signaling protocol used in Multi-Protocol Label Switching (MPLS) networks, that allows routers on the MPLS network to request specific quality of service from the network for particular flows, as provisioned by a network operator; and
Bandwidth Broker, an Internet2 bandwidth signaling protocol.

Other conventional or proprietary protocols may be used as well, and the invention is not limited to these particular identified protocols.

An administrative client 70 may be provided to enable an administrative interface to the visualization management service 42, network resource manager 44, and other services 60 to be used for example to set policy and other values, issue commands, control, and query the underlying services.

The administrative client 70 may be used to perform various services on the several components to which it is interfaced. Thus, the administrative client may be able to obtain information from the visualization management service such as the visualization events/routes scheduled for a particular client, visualization events currently running, other scheduled data transfers, the current network topology model, current parameter list, and many other types of information. Additionally, the administrative client may be used to set values on the visualization management service, such as internal timeout parameters, the types of statistics the visualization management service is to generate, etc.

After completion of a visualization event, reserved network resources are released. Optionally, where the network resources have been reserved for a set period of time, the network resources may be released automatically upon expiration of the set period of time. Completion of the visualization event and/or release of the network resources may be communicated to the AAA service to enable an account associated with the visualization event to be updated accordingly.

As discussed above and as shown in FIGS. 4 and 5, both the network resource manager and the visualization management service may be provided with the ability to schedule transactions on the network. The scheduling module may be configured in many different ways. For example, a request for a scheduled reservation within a specified window may be answered with a scheduled reservation during that window; a request for a reservation at a precise time can only be answered with a scheduled reservation for a visualization event at that time or failure. One reason for this constraint is that, in one embodiment, a scheduled reservation must fulfill the request and is not able to reserve resources to partially ftlfill requests or to fulfill partial requests. Stated another way, in this embodiment a client always receives what it asks for, or nothing. In this embodiment, if the client's request is too constrained to be fulfilled, the client should make a less constrained or different request. In other embodiments a partial fulfillment of a request may be tolerated and the invention is not limited to this embodiment. The extent to which a client's request is required to be fully or partially fulfilled may be set by policy by the administrative client 70.

In general, there are two types of requests, under-constrained and fully-constrained. An under-constrained request may be satisfied in two or more ways, whereas a fully-constrained request may be only satisfied in one way. For example, a request may specify that it would be preferred that the transfer occur at a particular time or within a particular time frame, but that the request may be fulfilled at any time within a larger time window. Alternatively, the request may specify that the visualization event should occur at the next available time. Additionally, the request may specify additional considerations, such as the cost of the visualization event, additional time constraints and preferences, accounting information, and many other aspects associated with the proposed visualization event.

The scheduled reservation will result in an allocation at the scheduled time. No further client action is needed to transform a scheduled reservation into an allocation; it happens automatically. If a special “allocation handle” or “resource ticket” is needed, then the client retrieves this from the network management service or visualization management service via push or pull. The scheduled reservation and/or allocation may be passed to the visualization control software configured to interact with the visualization processing center and visualization presentation center to coordinate any required pre-processing of the data to prepare the visualization to be transferred for presentation, and to coordinate the visualization event at the scheduled time over the scheduled resources.

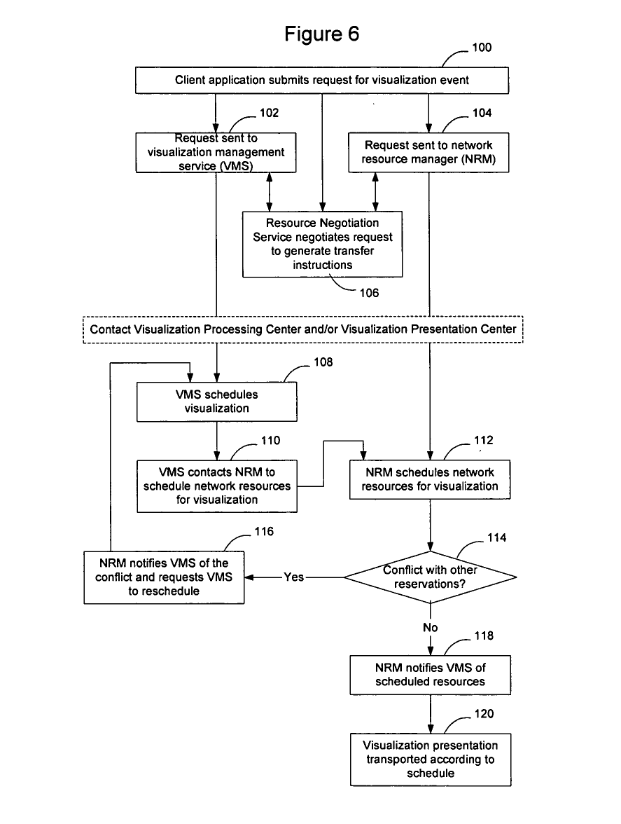

FIG. 6 illustrates a flow chart of an example of how requests may propagate through the visualization transfer service. As shown in FIG. 6, a client application submits a request for visualization event (100). This request may specify various parameters and policy values as discussed above, and will be sent to the visualization management service (102) or the network resources manager (104). The request may also be sent to another construct on the network and the invention is not limited to an embodiment in which the request is sent initially to one of these several illustrated components. Optionally, the request may be sent from the visualization management service or the network resource manager to a resource negotiation service (106) to negotiate the request.

If the request was passed to the visualization management service (102), the visualization management service schedules the visualization event (108) taking into account additional constraints imposed by other scheduled requests or requests that are also in the process of being scheduled. The visualization management service then contacts the network resource manager to schedule the network resources for the visualization (110).

Once a request is scheduled by the visualization management service, or if the request is passed directly to the network resource manager, the network resource manager ascertains the availability of the network resources and attempts to schedule the request by reserving available network resources to fulfill the request (112). The network resource manager also checks to see if the request conflicts with other reservations (114). If the visualization event conflicts with other reservations the network resource manager notifies the visualization management service of the conflict and requests the visualization management service to reschedule other requests or otherwise optimize scheduling of the request in view of the other contending requests (116). Once the visualization management service has scheduled/rescheduled the request (108), it notifies the network resource manager of the new schedule (110). This process iterates until an acceptable schedule is resolved. If there is no conflict, the network resource manager notifies the visualization management service of the scheduled request (118) so that the visualization management service has knowledge of the scheduled request and can thus use that knowledge in connection with scheduling other visualization events.

The responsible scheduling module, either in the visualization management service or the network resources manager, schedules the visualization event using the constraints in the request, and the availability of the network resources. In connection with this, the network resource availability may be dependent on other requests. Accordingly, the responsible scheduling module will interrogate its scheduling tables to ascertain if another request can be moved to accommodate this request when the request is not able to be fulfilled on the network resources due to a scheduling conflict. Additionally, once a scheduled transfer has been accepted, it is included in the scheduling table along with any under-constrained parameters so that the scheduled transfer may be rescheduled at a later time if another request is unable to be fulfilled.

At the designated time, the visualization event occurs by commencement of transmission of the visualization presentation over the scheduled resources (120). Other processes may be used as well and the invention is not limited to this particular process. The process illustrated in FIG. 6 may be implemented in hardware, software, firmware, or in numerous other manners and the invention is not limited to any particular implementation.

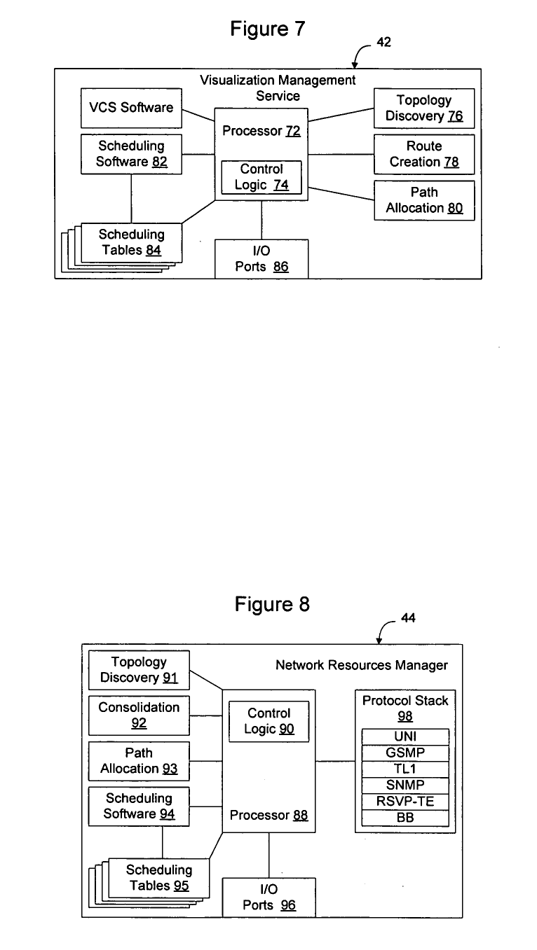

FIGS. 7-8 illustrate embodiments of network elements configured to implement the visualization management service and network resource manager components of the visualization transfer service according to an embodiment of the invention. These network services may be embodied in separate network elements, as illustrated, or they may be housed in the same network element and optionally the functionality of the elements may be combined to form one or more integrated services.

In the embodiment of the visualization management service illustrated in FIG. 7, the visualization management service 42 is configured to be implemented on a network element including a processor 72 having control logic 74 configured to implement the functions ascribed to the visualization management service discussed herein in connection with FIGS. 1-6. The network element has a native or interfaced memory containing data and instructions to enable the processor to implement the functions ascribed to it herein. For example, the memory may contain software modules configured to perform network topology discovery 76, route creation 78, path allocation 80, and scheduling 82. One or more of these modules, such as the scheduling software module 82, may be provided with access to scheduling tables 84 to enable it to read information from the tables and to take action on the tables, for example to learn of the existence of other scheduled reservations in connection with attempting to fulfill a reservation, and to alter existing reservations in connection with implementing or fulfilling a new reservation. I/O ports 86 are also provided to enable the network element to receive requests, issue instructions regarding fulfilled requests, and otherwise communicate with other constructs in the network.

In the embodiment of the network resources manager illustrated in FIG. 8, the network resources manager 44 is configured to be implemented on a network element including a processor 88 having control logic 90 configured to implement the functions ascribed to the network resource manager discussed herein. The network element, in this embodiment, has a native or interfaced memory containing data and instructions to enable the processor to implement the functions ascribed to it herein. For example, the memory may contain software modules configured to perform network topology discovery 91, consolidation 92, path allocation 93, and scheduling 94. One or more of these modules, such as the scheduling software module 94, may be provided with access to scheduling tables 95 to enable it to take other scheduled reservations into account when attempting to fulfill a reservation. I/O ports 96 are also provided to enable the network element to receive requests, issue instructions regarding fulfilled requests, and otherwise communicate with other constructs in the network. A protocol stack 98 may be provided to enable the network resources manager to undertake protocol exchanges with other network elements on the network to enable it to perform network discovery and management, and to reserve resources on the network.

The control logic described herein and the functions described herein as being performed by one or more modules or network elements may be implemented as one or more sets of program instructions that are stored in a computer readable memory within or interfaced to the network element and executed on a microprocessor. However, in this embodiment as with the previous embodiments, it will be apparent to a skilled artisan that all logic described herein can be embodied using discrete components, integrated circuitry such as an Application Specific Integrated Circuit (ASIC), programmable logic used in conjunction with a programmable logic device such as a Field Programmable Gate Array (FPGA) or microprocessor, or any other device including any combination thereof. Programmable logic can be fixed temporarily or permanently in a tangible medium such as a read-only memory chip, a computer memory, a disk, or other storage medium. Programmable logic can also be fixed in a computer data signal embodied in a carrier wave, allowing the programmable logic to be transmitted over an interface such as a computer bus or communication network. All such embodiments are intended to fall within the scope of the present invention.

It should be understood that various changes and modifications of the embodiments shown in the drawings and described herein may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

1. A method for transporting visualization information on a switched underlay network, the method comprising the steps of:
receiving a request for transportation of a visualization event;
scheduling resources on a switched underlay network for the visualization event;

2. The method of claim 1, wherein the resources are scheduled to interconnect a plurality of visualization processing centers to a visualization presentation center to convey the visualization event from the visualization processing centers to the visualization presentation center.

3. The method of claim 1, wherein the resources are scheduled to interconnect a visualization processing center to a plurality of visualization presentation centers to convey the visualization event from the visualization processing center to the plurality of visualization presentation centers.

4. The method of claim 1, further comprising a step of coordinating with a visualization processing center to coordinate generation of visualization information to be transported during the visualization event.

5. The method of claim 1, further comprising a step of coordinating with a visualization presentation center to coordinate availability of visualization presentation resources for the visualization event.

6. The method of claim 1, wherein the request is received from a visualization client, said visualization client being associated with at least one of a visualization processing center and a visualization presentation center.

7. The method of claim 1, wherein the request is an under constrained request.

8. The method of claim 1, wherein the switched underlay network is an optical network, and wherein the step of scheduling resources on the switched underlay network comprises reserving optical resources for transmission of the visualization event.

9. The method of claim 8, wherein the optical resources comprise a plurality of optical wavelengths, that collectively form an optical path through the optical network.

10. The method of claim 8, wherein the optical resources comprise a path through the network from at least one visualization processing center to a visualization presentation center.

11. The method of claim 10, wherein the visualization processing center comprises a plurality of computers configured to create high resolution visualizations from a data set, and wherein the visualization presentation center comprises a plurality of monitors configured to display high resolution visualization information.

12. A method for displaying high resolution visualization events at a visualization presentation center, the method comprising the steps of:
receiving visualization event signals from a switched underlay network in at least one of a native format and a format restorable to a native format; and
using the signals in the native format to directly display the visualization event on at least one visualization display.

13. The method of claim 12, further comprising at least one of the step of decompressing the signals and decrypting the visualization event signals to restore the visualization event signals to the native format.

14. The method of claim 12, wherein the native format is at least one of Red Green Blue (RGB) color format and YUV color format, and wherein the visualization display is configured to use the native format signals to generate images.

15. The method of claim 12, further comprising a step of de-multiplexing the signals to two or more visualization displays, each of said displays being configured to generate images from the native format signals.

16. The method of claim 12, wherein the visualization event signals are received from more than one visualization processing center.

17. The method of claim 16, wherein the visualization event signals are for one presentation to be displayed on a common group of display monitors forming the visualization display.

18. The method of claim 16, wherein the visualization event signals are for multiple presentations to be displayed on different display monitors of the at least one visualization display.

19. A method of providing high resolution visualization signals to a switched underlay network, the method comprising the steps of:
generating high resolution visualization signals containing visualization information; and
outputting the high resolution visualization signals onto a switched underlay optical network in a native format, said native format being suitable to be used by at least one display associated with a visualization presentation center to display the visualization information.

20. An apparatus for enabling high resolution visualization information to be transported on a switched underlay optical network, the apparatus comprising:
a visualization management service configured to interface with visualization entities associated with visualization events; and
a network resource manager configured to interface with network resources associated with the switched underlay optical network.

21. The apparatus of claim 20, wherein the visualization management service is further configured to coordinate with the visualization entities to enable the visualization entities to generate and display visualization information transferred during a visualization event over the switched underlay optical network.

22. The apparatus of claim 20, wherein the network resource manager is further configured to reserve network resources on the switched underlay optical network for the visualization events.
